(19) United States
(12) Patent Application Publication
(10) Pub. No.: US 2009/0028216 A1
(43) Pub. Date: Jan. 29, 2009

(54) METHOD AND APPARATUS FOR GENERATING A RADIO FREQUENCY PULSE

(75) Inventor: Robert Ian Gresham, Somerville, MA (US)

Correspondence Address: TYCO TECHNOLOGY RESOURCES, 4550 NEW LINDEN HILL ROAD, SUITE 140, WILMINGTON, DE, 19808-2952, US

(73) Assignee: M/A-Com, Inc., Lowell, MA (US)

(21) Appl. No.: 11/828,499

(22) Filed: Jul. 26, 2007

(51) Int. Cl. H04J 13/00

(52) U.S. Cl. 375/130

(57) ABSTRACT

The invention is a method and circuit for generating a pulsed periodic signal comprising a sub-harmonic mixer and a control circuit adapted to cause the output signal of the sub-harmonic mixer to be pulsed.

### FIELD OF THE INVENTION

The invention pertains to generation of a radio frequency (RF) pulse. The invention is specifically useful in connection with radar, and, more particularly, generation of a pulsed radar output signal for ultra-wideband radar.

### BACKGROUND OF THE INVENTION

The invention pertains to the generation of pulsed RF signals for any application. However, the invention is particularly useful in connection with the field of radar, and particularly ultra-wideband radar. Ultra-wideband radar generally refers to radar systems having an instantaneous bandwidth of greater than 500 MHz.

In commercial radar systems, such as automotive radar used for detecting obstacles in front of or behind a vehicle for purposes of collision avoidance during parking and/or normal driving, regulations in the United States require that the radar signal be in a frequency range of 22-29 GHz. These types of radar systems typically output a pulsed radar output signal. An exemplary system of this type might generate a pulsed radar output signal of very high frequency, such as 24 GHz, pulsed at a rate of about 5 MHz, and with an extremely low duty cycle, such as on the order of less than 1% on-time. Generally, the shorter the pulse length/width, the better the range resolution of the system. For instance, a pulse width of 1 ns provides a target range resolution of approximately 7.5 cm.

Accordingly, for such applications, there is a need to generate pulses of an extremely high frequency RF signal (e.g., 24 GHz) with very quick rise and fall times and with a very short duty cycle. As those skilled in the related arts know, it is difficult to generate pulses with very quick rise and fall times, particularly when the input signal that is being pulsed is at a high frequency such as 22-29 GHz.

U.S. Pat. No. 6,987,419 discloses an absorptive microwave single pole single throw switch (SPST) fabricated in bipolar technology that can achieve extremely quick rise and fall times for such applications. This patent discloses a circuit comprised essentially of three differential pairs of transistors. A first one of the differential pairs (hereinafter termed the control differential pair) is coupled to control which one of the two other differential pairs (hereinafter called the absorptive differential pair and the output differential pair, respectively) the radar signal is steered toward. The control differential pair is controlled by a control signal at the pulse repetition frequency, e.g. 5 MHz, to alternately switch a continuous wave (CW) differential input signal at the radar frequency, e.g., 24 GHz, between the absorptive differential pair and the output differential pair. The voltage differential between the collector terminals of the two transistors forming the output differential pair is coupled to the output terminals. The voltage across the collectors of the transistors of the absorptive differential pair is absorbed in the circuit by virtue of connection to a virtual ground.

While the circuit and method disclosed in the aforementioned patent works very well and could be implemented in CMOS, it is best suited for bipolar transistor implementation.

It is desirable to develop a switching circuit that can be implemented in CMOS at least because it is generally less expensive to fabricate CMOS transistors than bipolar transistors.

Furthermore, in switching circuits in which an input signal that is always on is steered between two different paths, leakage of the incident signal must be considered. Specifically, the transistors that form the circuit may not turn completely on or off as would be most desirable. For example, the transistors may not be identical; or there may be other non-idealities associated with the circuit layout and fabrication that allow some level of signal propagation from the input to the output of the circuit. These characteristics define the isolation of the switch. Thus, when the switch is in the off state, i.e., when the current is being directed through the absorptive differential pair, signal still may leak through to the output terminals. Further, in applications such as high resolution radar, the switch may be off about 90 to 99.9% of the time. Hence, even a tiny leakage signal relative to the output signal, when integrated over time, could be greater than the desired output signal itself.

Leakage signals, of course, are undesirable. Particularly, for instance, the energy that would leak through in the aforementioned type of steering circuit would be from the CW source and, therefore, would be at the same frequency (e.g., 24 GHz) as the output signal. In a radar application, this could result in self jamming, i.e., the CW signal can leak through to the receiver side of the radar system directly, or be transmitted and reflected from an object toward the receiver creating further problems.

### SUMMARY OF THE INVENTION

In accordance with a first aspect of the invention, a circuit is provided for generating a pulsed periodic signal comprising a sub-harmonic mixer and a control circuit adapted to cause the output signal of the sub-harmonic mixer to be pulsed.

In accordance with a second aspect of the invention, a circuit is provided for generating a pulsed periodic output signal that is pulsed at a pulse rate comprising a sub-harmonic mixer coupled to mix first, second, and third sinusoidal input signals, wherein the second and third sinusoidal input signals have the same frequency and are 90° out of phase with each other, and generate a sinusoidal output signal having a frequency at the sum of the frequencies of the first, second, and third input signals and a control circuit adapted to cause the output signal of the sub-harmonic mixer to be pulsed at the pulse rate.

In accordance with a third aspect of the invention, a method is provided of generating a pulsed radio frequency output signal comprising the steps of multiplying a first periodic input signal at a first frequency with a second periodic input signal at a second frequency to generate an intermediate signal, multiplying the intermediate signal with a third periodic input signal having the second frequency and being 90° out of phase with the second input signal to generate an output signal at a frequency of the sum of the frequencies of the first, second, and third periodic input signals, and pulsing the output signal.

In accordance with a third aspect of the invention, a method is provided of generating a pulsed radio frequency output signal comprising the steps of mixing a first periodic input signal at a first frequency with a second periodic input signal and a third periodic input signal in a sub-harmonic mixer, the second and third input signals being in quadrature at a second frequency, and pulsing the sub-harmonic mixer on and off.

### BRIEF DESCRIPTION OF THE DRAWINGS

FIG. 1 is a block-level diagram of a pulse generating circuit in accordance with the principles of the present invention.

FIG. 2 is a circuit-level diagram of a pulse generating circuit in accordance with the principles of the present invention.

FIG. 3 is a block-level diagram of a first alternate embodiment of a pulse generating circuit in accordance with the principles of the present invention.

FIG. 4A is a block-level diagram of a second alternate embodiment of a pulse generating circuit in accordance with the principles of the present invention.

FIG. 4B is a block-level diagram of a third alternate embodiment of a pulse generating circuit in accordance with the principles of the present invention.

FIG. 5 is a circuit diagram of an exemplary embodiment of the control circuit in FIG. 1.

### DETAILED DESCRIPTION OF THE INVENTION

In accordance with the principles of the present invention, a pulsed radio frequency (RF) output signal is generated from one or more continuous wave input signals that are at frequencies much lower than the desired output signal by employing the principles of sub-harmonic mixing of signals to generate an output signal that is at a frequency that is much higher than the frequencies of the input signals.

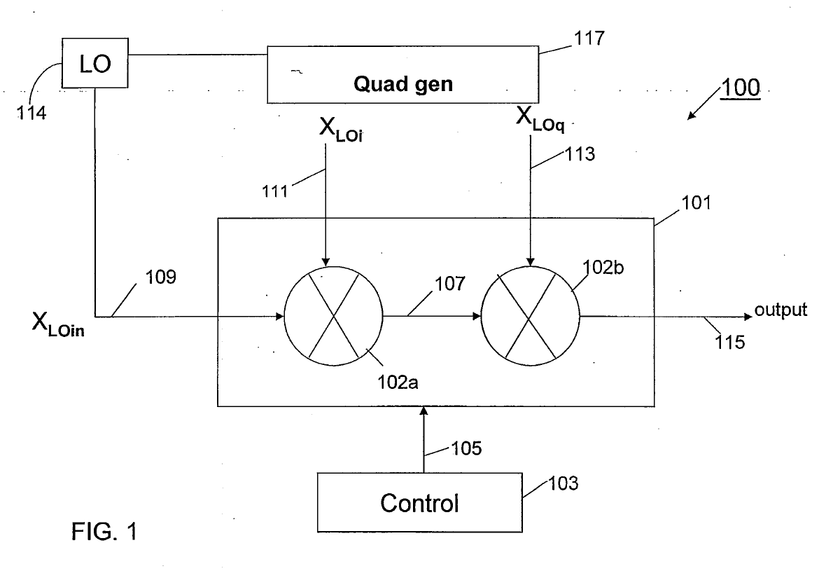

FIG. 1 is a block-level diagram illustrating a circuit 100 in accordance with the general principles of the present invention. The circuit 100 comprises one or more local oscillators 115, a quadrature generator 117, a sub-harmonic mixer 101, and a control circuit 103. The local oscillators 115 and quadrature generator 117 generate three input signals to the sub-harmonic mixer 101. The sub-harmonic mixer 101 receives the three input signals 109, 111, and 113 and mixes them in a manner to be described below to generate an output signal 115 at a higher frequency than any of the three input signals. The control circuit 103 generates a control signal 105 that turns the sub-harmonic mixer on and off at the desired pulse repetition frequency and duty cycle, e.g., 5 MHz at a duty cycle of less than 1%. The first input signal X_{LOin} (reference numeral 109 in FIG. 1) is a periodic signal having a particular frequency. The second and third input signals comprise two sinusoidal signals, X_{LOi} (reference numeral 111 in FIG. 1) and X_{LOq} (reference numeral 113 in FIG. 1) having the same frequency, but 90° out of phase with each other (i.e., in quadrature). The first input signal X_{LOin} may have the same or a different frequency as the second and third input signals, X_{LOi} and X_{LOq}, The first input signal, X_{LOin} can have any phase, relative to the other two, quadrature signals.

In fact, it is not necessary that X_{LOin} be at the same frequency as X_{LOi} and X_{LOq}, however, it is a very practical implementation because all three input signals can be generated from a single local oscillator, thereby reducing cost and circuitry.

The sub-harmonic mixer 101 comprises two multipliers 102a, 102b cascaded in series. The input signal X_{LOin} is first mixed with one of the quadrature input signals, e.g., X_{LOi}, in the first multiplier 102a. This multiplier 102a generates an output signal on line 107 having frequency components at X_{LOin}±X_{LOi}. Assuming for the sake of simplicity that all three of the input signals 109, 111, 113 are at 8 GHz, then the output signal from first multiplier 102a on line 107 has frequency components centered at 0 Hz and 16 GHz. The signal at 0 Hz can simply be ignored or easily filtered out because it is so far away in frequency from the 16 GHz signal. This output signal on line 107 from the first multiplier is input into the second multiplier 102b to be further multiplied with the X_{LOq} signal (also at 8 GHz, and 90° out of phase with X_{LOi}). The output on line 115 of the second multiplier 102b, therefore, will have frequency components at 16 GHz ±8 GHz (i.e., 8 GHz and 24 GHz). The frequency component that is at 8 GHz can be ignored or easily filtered out. Accordingly, an output signal at a frequency of 24 GHz is generated from three input signals, X_{LOin}, X_{LOi}, and X_{LOq}, at 8 GHz.

This 24 GHz continuous wave output signal on line 115 can be pulsed at the desired pulse rate and duty cycle by turning the entire mixer 101 on and off at the desired pulse repetition frequency and duty cycle. This is achieved in the exemplary embodiment illustrated in FIG. 1 by a bias control circuit 103 that controls the bias currents of the transistors that form the mixer 101 so as to turn all of them on or off simultaneously at the selected pulse rate and duty cycle.

The sub-harmonic mixer may comprise additional mixer stages to achieve other ratios of the frequencies of the input signals relative to the frequency of the output signal. For instance, inserting another multiplier stage with a first input from the preceding stage and a second input at X_{LOi} would generate an output at four times the frequency of the input signals.

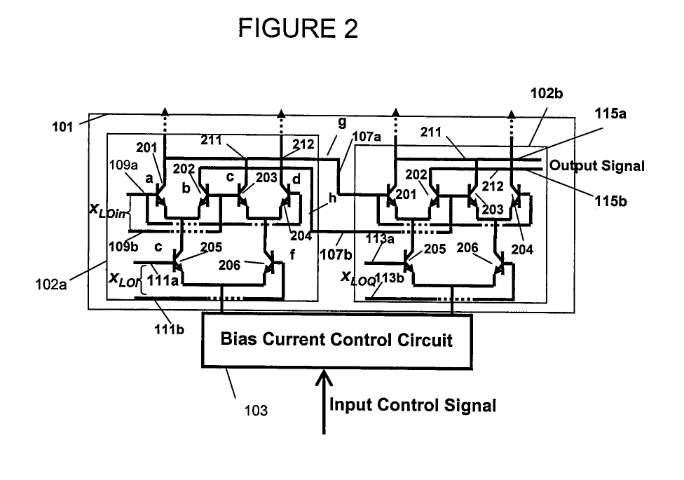

FIG. 2 is a circuit-level diagram of a particular implementation of this switched sub-harmonic pulse generator of FIG. 1. This is a differential embodiment. So all signals are double ended, comprising a positive signal line and a negative signal line. However, the principles of the invention also can be applied to a single-ended embodiment. Further, FIG. 2 illustrates an implementation with bipolar transistors. However, it should be understood that this is merely exemplary and the circuit can be fabricated using other fabrication technologies such as CMOS.

The sub-harmonic mixer portion 101 of the circuit comprises two cascaded multipliers 102a and 102b, as shown in FIG. 2. In this embodiment, each of those multipliers 102a, 102b is formed from well-known Gilbert multiplier cells, the operation of which is well-known and will only be described briefly herein. Basically, each Gilbert cell comprises six transistors arranged as three differential pairs of transistors. In each multiplier cell 102a, 102b, transistors 201 and 202 form one differential pair, transistors 203 and 204 form another differential pair, and transistors 205 and 206 form a third differential pair. In each cell, the collectors of transistors 201 and 203 are coupled together at node 211 and the collectors of transistors 202 and 204 are coupled together at node 212. The signal at the node 211 connecting the collectors of transistors 201 and 203 and the signal at the node 212 connecting the collectors of transistors 202 and 204 comprise the positive and negative ends of the differential output signal, respectively, of each Gilbert multiplier cell 102a, 102b. In each cell, the emitters of transistors 201 and 202 are coupled together and to the collectors of transistor 205 of the third differential pair. Likewise, the emitters of transistors 203 and 204 are coupled together and to the collector of transistor 206 of the third differential pair. In each cell, the emitters of transistors 205 and 206 are coupled together and to the bias current control circuit 103.

In the first Gilbert multiplier cell 102a, the bases of transistors 201 and 204 are coupled to one end 109a of the X_{LOin} input signal 109 and the bases of transistors 202 and 203 are coupled to the other end 109b of the X_{LOin} input signal 109. Also, in the first Gilbert multiplier cell 102a, the base of transistor 205 is coupled to one end 111a of the X_{LOi} input signal 111 and the base of transistor 206 is coupled to the other end 111b of the X_{LOi} input signal 111.

As mentioned above, the differential output of the first Gilbert multiplier cell 102a is taken at (1) the node 211 connecting the collectors of transistors 201 and 203 and (2) the node 212 connecting the collectors of transistors 202 and 204. This differential signal is provided as an input to the second Gilbert multiplier cell 102b on lines 107a and 107b. Specifically, the output at node 211 of the first Gilbert multiplier cell 102a is provided on line 107a to the bases of transistors 201 and 204 in the second Gilbert multiplier cell 102b and the output at node 212 of the first Gilbert multiplier cell 102a is provided on line 107b to the bases of transistors 202 and 203 in the second Gilbert multiplier cell 102b. Finally, one end 113a of the X_{LOq} input signal 113 is coupled to the base of transistors 205 in the second Gilbert multiplier cell 102b and the other end 113b of the X_{LOq} input signal 113 is coupled to the base input of transistor 206 of the second Gilbert multiplier cell 102b.

The output of the second Gilbert multiplier cell 102b, which is taken at nodes 211 and 212 of the second cell 102b, is the pulsed RF output signal provided on lines 115a and 115b.

Ignoring for the moment the bias current control circuit 103, which pulses the output of the sub-harmonic mixer on and off at the desired pulse rate (e.g., 100 MHz) and duty cycle (e.g.,1%), we shall describe how the sub-harmonic mixer multiplies the three CW input signals X_{LOin}, X_{LOi}, and X_{LOq} to produce an output signal at a frequency of X_{Loin}+X_{LO}i+X_{Loa}.

The basis of operation of a Gilbert multiplier cell is the well-known relationship that mixing two sinusoidal signals at the same frequency and in quadrature phase relationship to each other (e.g., sine/cosine) results in a sinusoidal output signal of half the amplitude and twice the frequency of the input signals. This relationship can be written mathematically as follows.

2·sin(ωt)·cos(ωt)=sin(2ωt) (1)

In continuous wave mode (i.e., assuming that the bias current control circuit 103 is not present and that the emitters of transistors 205 and 206 of both Gilbert multipliers cells are coupled to an infinite current well, e.g., ground), each Gilbert cell essentially performs the operation of multiplying the differential signal at the bases of its transistors 201, 202, 203, and 204 with the differential signal coupled to the bases of its transistors 205 and 206. Thus, in accordance with equation 1 above, sequentially multiplying X_{LOin} with two quadrature signals is like multiplying X_{LOin} with a single signal at twice the frequency of the two quadrature signals X_{LOi} and X_{LOq}, e.g. 16 GHz.

Hence, an output signal is generated with frequency components at 2X_{LOi}±X_{LOin} or 16 GHz±8 GHz or 8 GHZ and 24 GHz. The 8 GHz signal component can be filtered.

If X_{Loin} is at a different frequency than X_{LOi}, and X_{LOq}, e.g., 7.9 GHz, the output signal will be at a different frequency, e.g., 16 GHz+7.9 GHz=23.9 GHz.

Hence, the sub-harmonic mixer 101 generates an output signal at, e.g., 24 GHz from three input signals at, e.g., 8 GHz.

The RF output signal can be pulsed at this point by turning the sub-harmonic mixer on and off at the desired pulse rate and duty cycle. This can be achieved by any number of circuits. FIG. 2 illustrates merely one exemplary circuit 103.

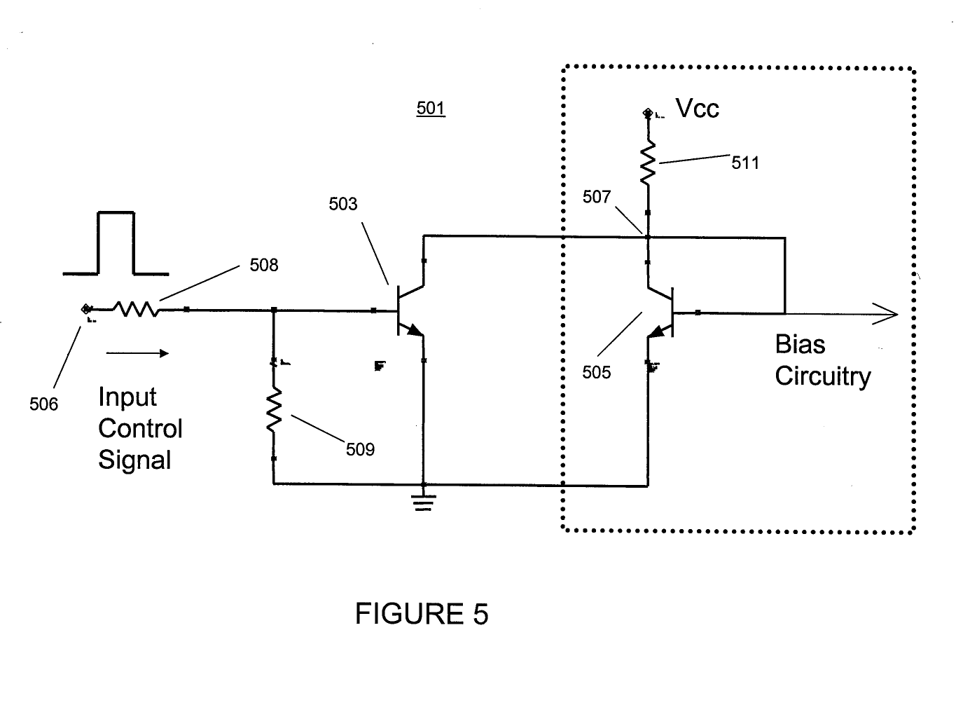

The bias current control circuit 103 provides one or more signals to the two multipliers 102a, 102b that switches them on and off at the desired pulse repetition frequency and duty cycle. FIG. 5 is a simplified circuit diagram of an exemplary circuit 501 that could be used as the control circuit 103. It comprises a transistor 505 coupled as a current mirror with its current flow terminals (collector and emitter) coupled between Vcc (through resistor 511) and ground. The current mirror transistor 505 actually may be embodiment within the mixer 101 itself. The base of transistor 505 is coupled to the bases of all of the current sources in the mixer 101. e.g., the bases of transistors 201, 202, 203, 204, 205, and 206 in mixer 101. Control circuit 501 further comprises a switch in the form of transistor 503 and a voltage divider composed of resistors 508 and 509 for setting the bias voltage for transistor 503 so that it can be turned on and off via the input control signal 506. The input control signal 506 is a pulse of the desired pulse repetition rate and duty cycle. When the input signal 506 is high, transistor 503 is turned on, which sends current through the collector-emitter path of transistor 503, thus bringing the collector node 507 to ground. This, in turn pulls the collector of current mirror transistor 505 to ground. This consequently also pulls the base of transistor 505 and the bases of all of the current source transistors in the mixer that are coupled to node 507 to ground, which turns all of them off. During the periods when the input control signal 506 is low, the current mirror transistor 505 remains on and, thus, the transistors in the mixer also remain on and the mixer simply operates as described hereinabove. The duty cycle of the control input signal 506 can be varied via a control signal in order to make the overall circuit more flexible. However, this is merely exemplary. For applications in which the duty cycle can be fixed, there would be no need for this feature.

It should be noted that, in contrast to the circuit described in aforementioned U.S. Pat. No. 6,987,419, the two multipliers 102a, 102b are not being turned on and off alternately (current steering), but that the entire sub-harmonic mixer 101 (which comprises the two multipliers 102a, 102b) is being turned on and off. This RF pulse generator circuit 100 suffers little or no signal leakage because, when the multipliers are switched off, there is no 24 GHz signal being generated that could leak through.

The present invention uses the mixer as a switch. The frequency translation of the input tone (e.g. 8 GHz to 24 GHz) happens as a result of the inherent non-linearities of the transistors. However, when the transistors are biased OFF, this mixing does not take place, and so, the 8 GHz tone does not get translated to 24 GHz, thus eliminating leakage at the 24 GHz signal frequency. There may still be some 8 GHz signal leaked from the input to the output, but because this is so far away from the band of interest, it is irrelevant. Furthermore, the two multipliers 102a, 102b in the sub-harmonic mixer 101 are cascaded so that the isolation provided is increased. (i.e. the 8 GHz tone does not get converted to 16 GHz which means that the second multiplier does not have the requisite inputs to generate the 24 GHz!!)

Furthermore and in any event, any leakage of the input signal 109, 111, 113 to the output 115 in the system will be at 8 GHz and can be easily filtered out because they are so far away in frequency from the 24 GHz output signal.

Other and additional advantages of the invention include the fact that the overall energy efficiency of this circuit (i.e., the ratio of input power to output power) will be greater than in previous implementations because the circuitry is operating at a much lower frequency than the transmitted signal (e.g., ⅓^{rd}). Generally, the lower the frequency of the signals, the greater the efficiency that can be achieved. Accordingly, it should generally take less input power to produce a given output power. Furthermore, by operating at one third of the output frequency circuit reliability and accuracy is increased.

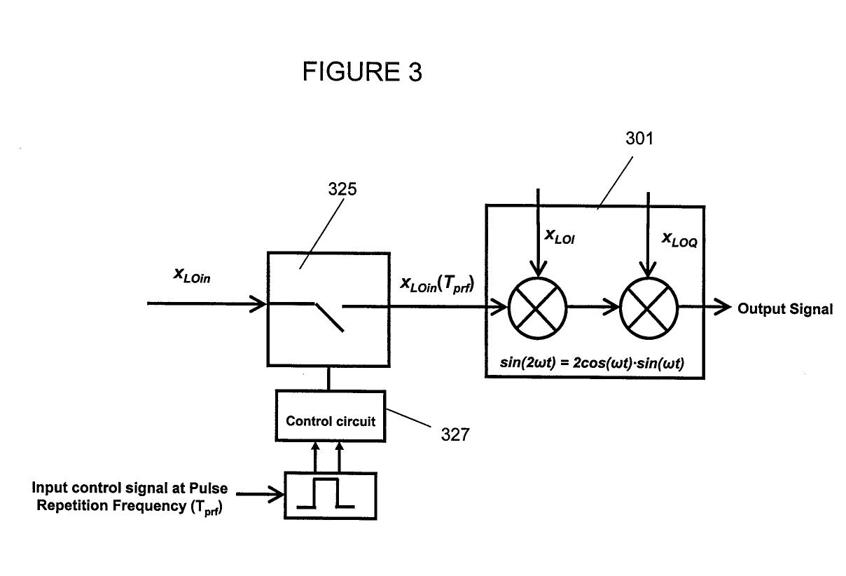

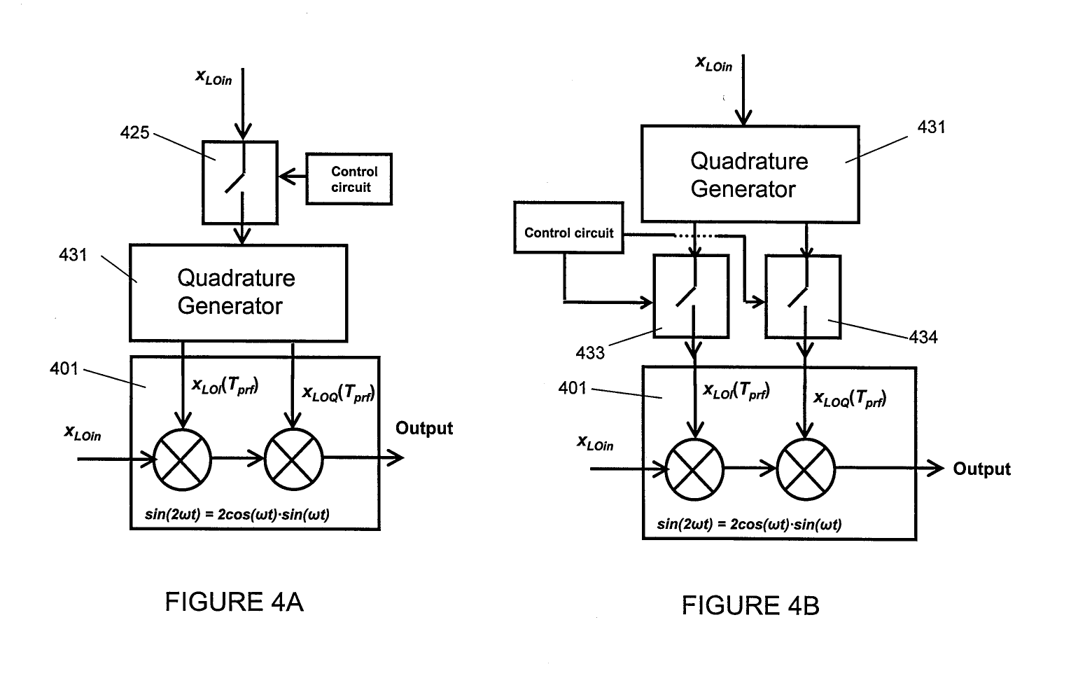

FIGS. 1 and 2 illustrate merely one exemplary circuit in accordance with the principles of the present invention. Many variations on these principles are possible. FIGS. 3, 4A, and 4B illustrate three exemplary alternative embodiments of the invention.

FIG. 3 illustrates an embodiment utilizing a passive sub-harmonic mixer 301, as opposed to the sub-harmonic mixer 101 illustrated in FIGS. 1 and 2 utilizing active Gilbert multipliers cells. Passive mixers typically use either diode rings or unbiased FET devices (cold FETs) as the basis for the two double-balanced mixers that perform for the double frequency translation operation, e.g., from 8 GHz to 24 GHz. In such a case, there would be no bias circuit such as in the embodiment of FIGS. 1 and 2 since there are no transistors to bias in a passive implementation. Accordingly, in this implementation, the sub-harmonic mixer 301 would be formed of two passive multiplier circuits 302a and 302b and the RF output signal would be pulsed by a different mechanism than that illustrated in FIGS. 1 and 2. In one embodiment as illustrated in FIG. 3, the input signal X_{LOin} could be switched by a switch 325 at the desired pulse repetition frequency and duty cycle. The switch 325 may be controlled by a control circuit 327 that receives an input control signal at the pulse frequency and duty cycle. Merely as an example, the switching circuit disclosed in the aforementioned U.S. Pat. No. 6,987,419 can be used as switch 325.

In other embodiments such as illustrated in FIGS. 4A and 4B, the quadrature input signals X_{LOi} and X_{LOq}, instead of X_{LOin}, can be gated at the pulse repetition frequency. The X_{LOi} and X_{LOq} signals can be gated either before quadrature generation (as illustrated in FIG. 4A) or after quadrature generation (as illustrated in FIG. 4B).

If all three of the input signals, X_{LOi}, X_{LOq}, and X_{LOin}, are at the same frequency (e.g., 8 GHz), they can all be generated from a single local oscillator. Accordingly, as illustrated in FIG. 4A, the original local oscillator signal can be used as X_{LOin} and also be provided to a quadrature generator 431 that will output two versions of the X_{LOin} signal that are 90° out of phase with each other, namely, X_{LOi} and X_{LOq}. A switching circuit 425 can gate the X_{LOin} signal that is input to the quadrature generator 431 at the pulse repetition frequency. The switching circuit 425, for example, can be the switching circuit disclosed in aforementioned U.S. Pat. No. 6,987,419.

FIG. 4B illustrates an alternate embodiment in which the X_{LOin} signal is fed directly into the quadrature generator 431 without switching and the outputs of the quadrature generator 431, X_{LOi} and X_{LOq} are instead switched by two switches 433, 434, respectively. This is a less cost effective implementation than the one illustrated in FIG. 4A since, in this implementation, two switches are used rather than one.

In accordance with an even further embodiment (not illustrated by the FIGS.), the quadrature signals X_{LOi} and X_{LOq} can be gated at the pulse repetition frequency by alternately creating and destroying the 90° phase difference between the two signals. As described above, the relationship at operation in the sub-harmonic mixer that generates signals at multiples of the frequencies of the input signals is the fact that X_{LOi} and X_{LOq} are 90° out of phase with each other. If X_{LOi} and X_{LOq} are not 90° out of phase with each other, the relationship is destroyed and the mixer will not produce a signal at the desired output frequency. Accordingly, another way to gate the output signal at the desired pulse repetition frequency and duty cycle is to switch the circuit components inside the quadrature generator 431 so as to alternately set the two output signals to be 90° out of phase with each other to some other phase relationship that does not produce an output signal at the desired frequency. This can be achieved, for instance, by the use of variable capacitors that are switched at the desired pulse repetition frequency and duty cycle.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A circuit for generating a pulsed periodic output signal comprising:
a sub-harmonic mixer; and
a control circuit adapted to cause the output signal of the sub-harmonic mixer to be pulsed.

2. The circuit of claim 1 wherein the control circuit is coupled to the sub-harmonic mixer and is adapted to turn the sub-harmonic mixer on and off at a pulse rate.

3. The circuit of claim 1 wherein the sub-harmonic mixer comprises:
a first multiplier coupled to multiply a first periodic input signal with a second periodic input signal and generate an output signal; and
a second multiplier coupled to multiply the output signal of the first multiplier with a third periodic input signal, the third periodic input signal having the same frequency as and being 90° out of phase with the second input signal, and generating an output signal comprising the pulsed periodic output signal.

4. The circuit of claim 3 wherein the first and second multipliers comprise Gilbert multipliers.

5. The circuit of claim 4 wherein the sub-harmonic mixer comprises at least one transistor and wherein the control circuit comprises circuitry that provide a bias voltage signal to the at least one transistor that alternately biases the at least one transistor on and off at the pulse rate.

6. The circuit of claim 3 wherein the first and second multipliers comprise passive circuit components.

7. The circuit of claim 3 wherein the sub-harmonic mixer is fabricated in CMOS.

8. The circuit of claim 1 wherein the first periodic input signal has the same frequency as the second and third periodic input signals.

9. The circuit of claim 8 wherein the pulsed periodic output signal has a frequency of three times the frequency of the first, second, and third periodic input signals.

10. The circuit of claim 9 wherein the first, second, and third periodic input signals are continuous wave sinusoidal signal.

11. The circuit of claim 8 further comprising a single local oscillator for generating the first, second, and third periodic input signals.

12. The circuit of claim 11 further comprising a quadrature generator coupled between the local oscillator and the sub-harmonic mixer for generating the second and third input signals from the local oscillator.

13. A radar system comprising the circuit of claim 1 wherein said pulsed periodic output signal is a radar output signal of the radar system.

14. A circuit for generating a pulsed periodic output signal that is pulsed at a pulse rate comprising:
a sub-harmonic mixer coupled to mix first, second, and third sinusoidal input signals, wherein the second and third sinusoidal input signals have the same frequency and are 90° out of phase with each other, and generate a sinusoidal output signal having a frequency at the sum of the frequencies of the first, second, and third input signals; and
a control circuit adapted to cause the output signal of the sub-harmonic mixer to be pulsed at the pulse rate.

15. The circuit of claim 14 wherein the sub-harmonic mixer comprises active circuit components including at least one transistor and wherein the control circuit comprises a current source adapted to generate a current that biases the at least one transistor on and off at the pulse rate.

16. The circuit of claim 14 wherein the control circuit turns the sub-harmonic mixer on and off at the pulse rate.

17. The circuit of claim 14 wherein the control circuit comprises a switch coupled to pulse the first input signal at the pulse rate.

18. The circuit of claim 14 wherein the control circuit comprises a switch coupled to pulse the second and third input signals at the pulse rate.

19. The circuit of claim 18 further comprising:
a local oscillator for generating a sinusoidal local oscillator signal; and
a quadrature generator coupled to receive the local oscillator signal and generate the second and third input signals from the local oscillator signal;
wherein the switch is coupled to the local oscillator signal to pulse the local oscillator signal into the quadrature generator.

20. The circuit of claim 15 wherein the sub-harmonic mixer comprises only passive circuit components.

21. A method of generating a pulsed radio frequency output signal comprising the steps of:
multiplying a first periodic input signal at a first frequency with a second periodic input signal at a second frequency to generate an intermediate signal;
multiplying the intermediate signal with a third periodic input signal having the second frequency and being 90° out of phase with the second input signal to generate an output signal at a frequency of the sum of the frequencies of the first, second, and third periodic input signals; and
pulsing the output signal.

22. The method of claim 21 wherein the step of pulsing the output signal comprises:
pulsing the first periodic input signal.

23. The method of claim 21 wherein the step of pulsing the output signal comprises:
pulsing the second and third periodic input signals.

24. The method of claim 21 wherein the step of pulsing the output signal comprises:
pulsing the step of multiplying the periodic signal and pushing the step of the multiplying the intermediate signal on and off simultaneously.

25. A method of generating a pulsed radio frequency output signal comprising the steps of:
mixing a first periodic input signal at a first frequency with a second periodic input signal and a third periodic input signal in a sub-harmonic mixer, the second and third input signals being in quadrature at a second frequency; and
pulsing the sub-harmonic mixer on and off.
